(19) United States
(12) Patent Application Publication
(10) Pub. No.: US 2009/0161008 A1
(43) Pub. Date: Jun. 25, 2009

(54) Communication apparatus, information processing method, and program

(75) Inventor: Kensuke Motomura, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/316,769

(22) Filed: Dec. 16, 2008

(30) Foreign Application Priority Data
Dec. 21, 2007 (JP) P2007-330453

(51) Int. Cl. H04N 7/01

(52) U.S. Cl. 348/441; 348/E07.003

(57) ABSTRACT

A communication apparatus connected to one or more apparatuses via an interface having at least a signal channel unidirectionally transmitting a baseband signal and a bidirectional control channel used for control is provided. The communication apparatus includes an equipment information obtaining unit, a selection unit, and an instruction unit. The equipment information obtaining unit obtains equipment information about each of the one or more apparatuses via the interface, containing at least capable/incapable information representing whether the apparatus is capable of performing conversion processing for converting a format of the signal. The selection unit selects a single apparatus from the communication apparatus and the one or more apparatuses capable of performing the conversion processing, as an executing apparatus in which the conversion processing should be executed. The instruction units instructs the executing apparatus to execute the conversion processing or prohibit the conversion processing via the control channel.

### CROSS-REFERENCE TO RELATED APPLICATIONS

The present application claims benefit of priority of Japanese patent Application No. 2007-330453 filed in the Japanese Patent Office on Dec. 21, 2007, the entire disclosure of which is incorporated herein by reference.

### BACKGROUND OF THE INVENTION

1. Field of the Invention

The present invention relates to a communication apparatus, an information processing method, and a program. Particularly, the present invention relates to a communication apparatus, an information processing method, and a program which allow properly conversion processing for converting signal formats in apparatus having at least a signal channel unidirectionally transmitting a baseband signal and a bidirectional control channel used for control, and being connected via an interface such as HDMI (High-Definition Multimedia Interface)®.

2. Description of Related Art

In recent years, an HDMI® has gradually become widely used as a communication interface for transmitting a digital television signal, i.e., a baseband (uncompressed) image (moving image) signal and an audio signal accompanying the image, to, e.g., a television receiver (TV), a projector, and other displays from a DVD (Digital Versatile Disc) player, a set-top box, and other AV sources, at high speed.

An HDMI® standard is an interface standard for digital household appliances (home electric products), and is obtained by arranging DVI (Digital Visual Interface) for home-use AV (Audio Visual) equipment. Namely, DVI which is a connection standard specification for connecting a personal computer (PC) to a display has been provided by, e.g., adding an audio transmitting function for transmitting audio, a copyright protection function for preventing illegal copying of digital content and the like, and a color difference transmitting function for transmitting a color difference signal, to DVI (see, e.g., “High-Definition Multimedia Interface Specification Version 1.3a” Nov. 10, 2006 (Non-Patent Document 1)).

Here, there are three types of apparatuses (hereinafter called “HDMI® apparatus”) connected via the HDMI®: an HDMI® source, an HDMI® sink, and an HDMI® repeater.

The HDMI® source has an output terminal outputting image/audio signals via the HDMI®. The HDMI® sink has an input terminal inputting image/audio signals via the HDMI®. The HDMI® repeater has one or more input terminals and one or more output terminals, and behaves just as both an HDMI® source and an HDMI® sink.

The HDMI® has TMDS (Transition Minimized Differential Signaling) channels as a signal channel unidirectionally transmitting baseband image/audio signals to the HDMI® sink from the HDMI® source via a necessary HDMI® repeater, a CEC line (Consumer Electronics Control Line) as a bidirectional control channel used for controlling the HDMI® source, the necessary HDMI® repeater, and the HDMI® sink, as well as other channels.

Namely, in the HDMI®, the TMDS channels are employed for a physical layer, and the CEC line is employed for connecting a control system for the whole apparatus connected by the HDMI®.

Furthermore, in the HDMI®, HDCP (High-bandwidth Digital Content Protection) is adopted to encrypt signals for implementing a copyright protection function.

Still furthermore, in the HDMI®, EDID (Extended Display Identification Data) is adopted for authentication between apparatuses.

Namely, a DDC/EDID method by VESA (Video Electronics Standard Association) is adopted for the authentication between HDMI® apparatuses.

A DDC (Display Data Channel) is used for the HDMI® source to read EDID (E-EDID (Enhanced Extended Display Identification Data)) from the HDMI® sink and also from the HDMI® repeater.

Namely, each of the HDMI® sink and the HDMI® repeater has an EDIDROM (EDID Read Only Memory) storing EDID which is information about its own configuration and capability. The HDMI® source reads EDID stored in the EDIDROM of each-of the HDMI® sink and the HDMI® repeater via the DDC, and recognizes the configuration and capability of each of the HDMI® sink and the HDMI® repeater on the basis of the EDID.

Here, the EDID includes information, for example, a brand (manufacturer) and a model number of the HDMI® sink, and signal formats (e.g., image resolutions and the like) supported by the HDMI® sink.

FIG. 1 shows a configuration example of an AV system (the term “system” used herein means a logical set configuration of a plurality of apparatuses, irrespective of whether or not the apparatus each having its own configuration are arranged within the same enclosure) composed of a plurality of apparatuses connected by the HDMI®.

In FIG. 1, the AV system is configured such that a DVD player 11 as the HDMI® source and an AV amplifier 12 as the HDMI® repeater are connected by an HDMI® cable 1, and the AV amplifier 12 as the HDMI® repeater and a TV 13 as the HDMI® sink are connected by an HDMI® cable 2.

The DVD player 11 as the HDMI® source reads EDID about the AV amplifier 12 as the HDMI® repeater via the cable 1, and recognizes image resolutions supported by the AV amplifier 12 on the basis of the EDID.

Also, the DVD player 11 as the HDMI® source reads EDID about the TV 13 as the HDMI® sink via the cable 1, the AV amplifier 12, and the cable 2, and recognizes image resolutions supported by the TV 13 on the basis of the EDID.

Here, how to use the resolutions supported by the HDMI® sink and the HDMI® repeater, which are recognized by the HDMI® source is not particularly specified in the HDMI® standard. Thus, it has been proposed to recommend items described in Appendix F (Page 152) of the Specification for the HDMI® (Non-Patent Document 1)).

Accordingly, in each of the HDMI® source, the HDMI® repeater, and the HDMI® sink, what kind of processing is to be performed as conversion processing (scaling, upsampling, resolution conversion) for converting signal formats such as image resolutions is at the discretion of each manufacturer.

However, many manufacturers typically provide an auto mode and a manual mode as conversion processing modes.

In the auto mode, the HDMI® source converts a signal for an image (image signal) into an image signal having the highest resolution supported by the HDMI® sink and outputs the converted image signal.

In the manual mode, the HDMI® source causes the HDMI® sink to display at lower resolution than the highest resolution supported by the HDMI® sink on a menu. Furthermore, the HDMI® source selects one of the resolutions displayed on the menu in response to a user operation, and converts the image signal into an image signal having the selected resolution and outputs the converted image signal.

Here, in the manual mode, the resolution selected by a user will hereinafter be called specified resolution as appropriate.

### SUMMARY OF THE INVENTION

As described above, in the manual mode, a signal is converted into a signal having a specified resolution in response to a user operation, and thus proper conversion processing may not be performed in some cases.

Namely, in the AV system of FIG. 1, it is supposed that the format of an image signal reproduced from a DVD by the DVD player 11 has, e.g., 480i (interlace mode with 480 horizontal scanning lines), and that the (highest) resolution (hereinafter also called “supported resolution” as appropriate) format supported by the TV 13 is, e.g., 1080i (interlace mode with 1080 horizontal scanning lines).

Furthermore, it is supposed that the user has set the DVD player 11, the AV amplifier 12, and the TV 13 to the manual mode as their processing modes, and also has selected, e.g., 720p (progressive (non-interlace) mode with 720 (non-interlaced) horizontal scanning lines) as a specified resolution for the DVD player 11 and the AV amplifier 12.

In this case, the DVD player 11 performs conversion processing which converts a 480i image signal reproduced from the DVD into a 720p image signal having the specified resolution, and supplies the 720p image signal to the AV amplifier 12 via the cable 1.

Since the image signal supplied to the AV amplifier 12 from the DVD player 11 is already an image signal having the specified resolution of the AV amplifier 12, the AV amplifier 12 does not particularly perform conversion processing on the 720p image signal from the DVD player 11 as long as the resolution is concerned, so that the image signal is passed as it is to provide the TV 13 with the passed image signal the TV 13 via the cable 2.

The TV 13 performs conversion processing for converting the 720p image signal from the AV amplifier 12 into a 1080i image signal having the supported resolution, and displays (an image corresponding to) the resultant 1080i image signal thereon.

Accordingly, in the AV system of FIG. 1, the 480i image signal reproduced from the DVD is subjected to the conversion processing by each of the DVD player 11 which is the HDMI® source and the TV 13 which is the HDMI® sink, and the resultant video is displayed on the TV 13.

However, the conversion processing performed by each of the DVD player 11 and the TV 13 is not performed by taking into consideration of conversion processing to be performed at any other HDMI® apparatus. As a result, if both the DVD player 11 and the TV 13 perform their own conversion processing, the conversion processing performed by one of the DVD player 11 and the TV 13 may affect the conversion processing performed by the other, so that the image quality of the image displayed on the TV 13 may be degraded eventually.

Accordingly, the fact that a plurality of HDMI® apparatuses perform their conversion processing may sometimes be improper. In addition, from the viewpoint of consistency in (algorithms of) conversion processing, it is desirable that conversion processing is performed by a single HDMI® apparatus as much as possible.

It is noted that if a plurality of HDMI® apparatuses constituting the AV system are capable of performing conversion processing, there may exist the superiority or inferiority in the conversion processing performed by each of the plurality of HDMI® apparatuses (the quality of an image obtained by the conversion processing) in some cases.

Furthermore, replacement of a part of the plurality of HDMI® apparatuses constituting the AV system may further cause the superiority or inferiority in the conversion processing performed by each of the plurality of HDMI® apparatuses in some cases.

As described above, when one of the plurality of HDMI® apparatuses constituting the AV system performs conversion processing, it is desirable that conversion processing which the user deems good (superior) be performed.

Accordingly, it is desirable to allow conversion processing for converting signal formats to be properly performed with simple operation.

In accordance with a communication apparatus and a computer readable medium including a program according to a first aspect of the present invention, there is provided a communication apparatus connected to one or more apparatuses via an interface having at least a signal channel unidirectionally transmitting a baseband signal and a bidirectional control channel used for control, and a computer readable medium including a program for causing a computer to function as the communication apparatus. The communication apparatus includes an equipment information obtaining unit, a selection unit, and an instruction unit. The equipment information obtaining unit obtains equipment information about each of the one or more apparatuses connected via the interface, containing at least capable/incapable information representing whether the apparatus is capable of performing conversion processing for converting a format of the signal. The selection unit selects a single apparatus from the communication apparatus and the one or more apparatuses capable of performing the conversion processing, as an executing apparatus in which the conversion processing should be executed. The instruction unit: instructs, when the executing apparatus is the communication apparatus, all of the one or more apparatuses capable of performing the conversion processing to prohibit the conversion processing via the control channel; and instructs, when the executing apparatus is one of the one or more apparatuses capable of the conversion processing, the executing apparatus of the one or more apparatuses capable of performing the conversion processing to execute the conversion processing via the control channel, and also instructs the communication apparatus to prohibit the conversion processing and other apparatus to prohibit the conversion processing via the control channel.

In accordance with an information processing method according to a first aspect of the present invention, there is provided a communication apparatus connected to one or more apparatuses via an interface having at least a signal channel unidirectionally transmitting a baseband signal and a bidirectional control channel used for control. The information processing method includes the steps of: obtaining, by the communication apparatus, equipment information about each of the one or more apparatuses connected via the interface, containing at least capable/incapable information representing whether the apparatus is capable of performing conversion processing for converting a format of the signal; selecting a single apparatus from the communication apparatus and the one or more apparatuses capable of performing the conversion processing, as an executing apparatus in which the conversion processing should be executed; and instructing, when the executing apparatus is the communication apparatus, all of the one or more apparatuses capable of performing the conversion processing to prohibit the conversion processing, via the control channel, and instructing, when the executing apparatus is one of the one or more apparatuses capable of performing the conversion processing, the executing apparatus of the one or more apparatuses capable of performing the conversion processing to execute the conversion processing, via the control channel, and also instructing the communication apparatus to prohibit the conversion processing and other apparatus to prohibit the conversion processing, via the control channel.

In the first aspect described above, equipment information about each of the one or more apparatuses connected via the interface, containing at lest capable/incapable information representing whether the apparatus is capable of performing conversion processing for converting a format of the signal is obtained, and a single apparatus is selected from the communication apparatus and the one or more apparatuses capable of performing the conversion processing, as an executing apparatus in which the conversion processing should be executed. Then, when the executing apparatus is the communication apparatus, all of the one or more apparatuses capable of performing the conversion processing are instructed to prohibit the conversion processing, via the control channel, whereas when the executing apparatus is one of the one or more apparatuses capable of performing the conversion processing, the executing apparatus of the one or more apparatuses capable of performing the conversion processing is instructed to execute the conversion processing, via the control channel, and also the communication apparatus is instructed to prohibit the conversion processing and other apparatus is instructed to prohibit the conversion processing, via the control channel.

In accordance with a communication apparatus and a computer readable medium including a program according to a second aspect of the present invention, there is provided a communication apparatus connected to another apparatus via an interface having at least a signal channel unidirectionally transmitting a baseband signal and a bidirectional control channel used for control, and a computer readable medium including a program for causing a computer to function as the communication apparatus. The communication apparatus includes a providing unit and an execution control unit. The providing unit provides equipment information about the communication apparatus containing at least capable/incapable information representing whether the apparatus is capable of performing conversion processing for converting a format of the signal, to the another apparatus. The execution control unit controls execution of the conversion processing in accordance with an instruction from the another apparatus received via the control channel when the apparatus is capable of performing the conversion processing.

In accordance with an information processing method according to a second aspect of the present invention, there is provided a communication apparatus connected to another apparatus via an interface having at least a signal channel unidirectionally transmitting a baseband signal and a bidirectional control channel used for control. The information processing method includes the steps of: providing, by the communication apparatus, equipment information about the communication apparatus containing at least capable/incapable information representing whether the apparatus is capable of performing conversion processing for converting a format of the signal, to the another apparatus; and controlling execution of the conversion processing in accordance with an instruction from the another apparatus received via the control channel when the apparatus is capable of performing the conversion processing.

In the second aspect described above, equipment information about the communication apparatus containing at least capable/incapable information representing whether the apparatus is capable of performing conversion processing for converting a format of the signal is provided to the another apparatus. Then, when the apparatus is capable of performing the conversion processing, execution of the conversion processing is controlled in accordance with an instruction from the another apparatus received via the control channel.

The communication apparatus may be an independent apparatus or an internal block constituting a single apparatus.

Furthermore, the program can be provided by transmission via a transmission medium or as recorded on a recording medium.

According to embodiments by the first and second aspects of the present invention, conversion processing for converting signal formats can be performed properly.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

FIG. 1 is a block diagram showing a configuration example of a known AV system;

FIG. 2 is a block diagram showing a configuration example of an AV system according to an embodiment of the present invention;

FIG. 3 is a block diagram showing a configuration example of a DVD player 21;

FIG. 4 is a block diagram showing a configuration example of an AV amplifier 22;

FIG. 5 is a block diagram showing a configuration example of a TV 23;

FIG. 6 is a block diagram showing a configuration example of an HDMI® transmitting section 106 and an HDMI® receiving section 214;

FIG. 7 is a diagram illustrating processing mode transition;

FIG. 8 is a diagram showing a resolution setting menu;

FIG. 9 is a flowchart illustrating processing with the DVD player 21;

FIG. 10 is a flowchart illustrating select-mode processing;

FIG. 11 is a flowchart illustrating processing with the AV amplifier 22; and

FIG. 12 is a flowchart illustrating processing with the TV 23.

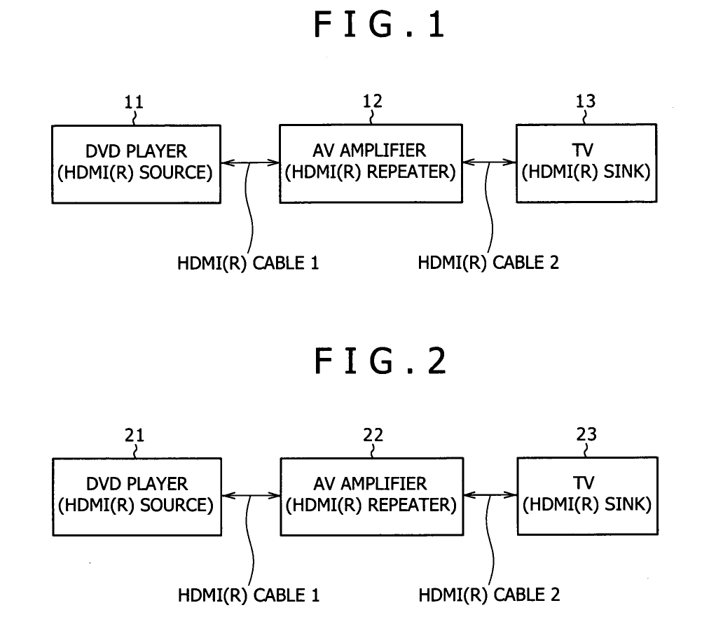

### DETAILED DESCRIPTION OF EMBODIMENTS

FIG. 2 is a block diagram showing a configuration example of an AV system according to an embodiment of the present invention.

In FIG. 2, the AV system includes a DVD player 21, an AV amplifier 22, and a TV 23, which are HDMI® apparatuses.

The DVD player 21 is a communication apparatus functioning as an HDMI® source, and is connected to the AV amplifier 22 via an HDMI® cable 1.

The DVD player 21 reproduces DVD, and transmits (supplies) the resultant image and audio signals to the AV amplifier 22 via the cable 1.

The DVD player 21 also obtains equipment information about each of one or more HDMI® apparatuses connected via an HDMI®, which contains at least capable/incapable information representing whether the HDMI® apparatus is capable or incapable of conversion processing for converting signal formats, and recognizes an HDMI® apparatus capable of performing the conversion processing, from the capable/incapable information contained in the equipment information.

It is noted here that all of the DVD player 21, the AV amplifier 22, and the TV 23 are supposed to be HDMI® apparatuses capable of performing the conversion processing.

Here, the HDMI® apparatus capable of performing the conversion processing will hereinafter be called also as “conversion-capable apparatus” as appropriate. In the present embodiment, all of the DVD player 21, the AV amplifier 22, and the TV 23 are conversion-capable apparatus.

Furthermore, any of the conversion-capable apparatus excluding the HDMI® source will hereinafter be called as “controlled conversion-capable apparatus” as appropriate. In the present embodiment, the AV amplifier 22 and the TV 23 are controlled conversion-capable apparatus.

The DVD player 21 selects one conversion-capable apparatus from a plurality of conversion-capable apparatuses including the DVD player 21 itself, i.e., the DVD player 21, the AV amplifier 22, and the TV 23, as an executing apparatus in which the conversion processing should be executed.

It is noted that if there is a single conversion-capable apparatus among the HDMI® apparatuses constituting the AV system, that conversion-capable apparatus is selected as the executing apparatus.

If the executing apparatus is the DVD player 21 itself, the DVD player 21 instructs all the other conversion-capable apparatus, i.e., the controlled conversion-capable apparatus, i.e., the AV amplifier 22 and the TV 23 in FIG. 2 to prohibit the conversion processing via a CEC line as an HDMI® control channel.

Furthermore, if the executing apparatus is one of the controlled conversion-capable apparatus, the DVD player 21 instructs the executing apparatus among the controlled conversion-capable apparatuses to execute the conversion processing, via the CEC line of the HDMI®, and also instructs any other controlled conversion-capable apparatuses to prohibit the conversion processing, via the CEC line of the HDMI®.

Namely, for example, if the executing apparatus is either the AV amplifier 22 or the TV 23 which is the controlled conversion-capable apparatus, such one of the AV amplifier 22 and the TV 23 is instructed to execute the conversion processing, and the other is instructed to prohibit the conversion processing.

The AV amplifier 22 is a communication apparatus functioning as an HDMI® repeater, and is connected to the DVD player 21 via the HDMI® cable 1, and is connected to the TV 23 via an HDMI® cable 2.

The AV amplifier 22 receives the image and audio signals supplied from the DVD player 21 via the cable 1, and amplifies the signals as necessary, and then transmits (supplies) the signals to the TV 23 via the cable 2.

Furthermore, the AV amplifier 22 provides the DVD player 21 as the HDMI® source which is another HDMI® apparatus with equipment information about the AV amplifier 22 itself, which contains at least capable/incapable information representing whether it is capable of performing conversion processing for converting signal formats.

Then, the AV amplifier 22, if capable of performing the conversion processing, controls execution of the conversion processing, as instructed by the DVD player 21 as the HDMI® source via the CEC line of the HDMI®.

The TV 23 is a communication apparatus functioning as the HDMI® sink, and is connected to the AV amplifier 22 via the HDMI® cable 2.

The TV 23 displays an image and outputs an audio sound responsive to signals supplied thereto from the AV amplifier 22 via the cable 2.

Furthermore, the TV 23 provides the DVD player 21 as the HDMI® source as another HDMI® apparatus with equipment information about the TV 23 itself, which contains at least capable/incapable information representing whether it is capable of performing conversion processing for converting signal formats.

Then, if the conversion processing is capable of performing, the TV 23 controls execution of the conversion processing as instructed by the DVD player 21 as the HDMI® source via a CEC line of the HDMI®.

When the format for an image signal from the AV amplifier 22 is not yet compatible with any resolution supported by the TV 23, the TV 23 converts the image signal from the AV amplifier 22 into an image signal having a resolution supported by the TV 23 irrespective of any instruction from, e.g., the DVD player 21, and displays the converted video signal.

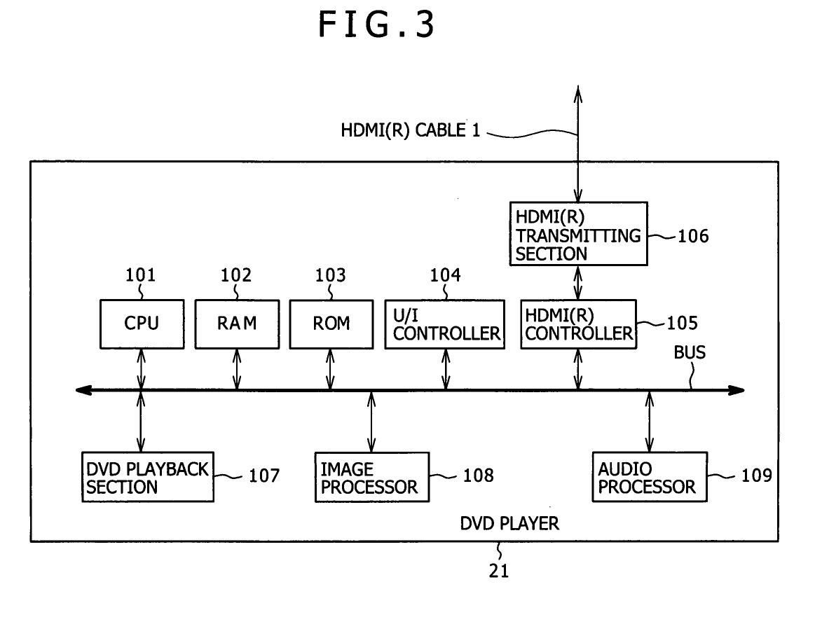

FIG. 3 is a block diagram showing a configuration example of the DVD player 21 of FIG. 2.

The DVD player 21 includes a central processing unit (CPU) 101, a random access memory (RAM) 102, a read only memory (ROM) 103, a user interface (U/I) controller 104, an HDMI® controller 105, an HDMI® transmitting section 106, a DVD playback section 107, an image processor 108, and an audio processor 109. The CPU 101, the RAM 102, the ROM 103, the U/I controller 104, and the HDMI® controller 105, and the DVD playback section 107, the image processor 108, and the audio processor 109 are mutually interconnected via a bus.

The CPU 101 executes a program stored in the ROM 103 to control over the whole of the DVD player 21.

Programs to be executed by the CPU 101 are loaded into the RAM 102. The RAM 102 also functions as a work area for the CPU 101. Namely, the RAM 102 stores data necessary for the CPU 101 to operate.

The ROM 103 stores a program to be executed by the CPU 101 to perform later-described processing (control).

The U/I controller 104 receives operational signals corresponding to user operation from a remote controller (not shown) for remote-controlling the DVD player 21, and operational signals inputted by the user operating operation buttons and the like provided on an operation panel (not shown) of the DVD player 21, and supplies these operational signals to the CPU 101.

The HDMI® controller 105 controls transmission of an AV signal (one or both of an image signal and an audio signal), transmission/reception of control signals, and the like in the HDMI® transmitting section 106, as controlled by the CPU 101.

The HDMI® transmitting section 106 transmits a baseband AV signal to the AV amplifier 22 via the cable 1, and also transmits/receives control signals to/from the AV amplifier 22 via the cable 1, as controlled by the HDMI® controller 105.

The DVD playback section 107 reproduces an AV signal and the like from a DVD (not shown) and outputs the reproduced signal and the like onto the bus, as controlled by the CPU 101.

The image processor 108 performs conversion processing (resolution conversion, upsampling, scaling processing, and the like) and other image processing on an image signal in the AV signal supplied thereto from the DVD playback section 107 via the bus.

The audio processor 109 performs encoding, decoding, sampling processing, and other audio processing on an audio signal among the AV signals supplied thereto from the DVD playback section 107 via the bus.

In the DVD player 21 thus configured, the DVD playback section 107 reproduces the AV signal and the like from the DVD in response to user operation, and supplies the reproduced signal to the image processor 108 and the audio processor 109 over the bus.

The image processor 108 performs the necessary image processing on the image signal among the AV signals from the DVD playback section 107, and supplies the resultant signal to the HDMI® controller 105 via the bus.

The audio processor 109 performs the necessary audio processing on the audio signal among the AV signals from the DVD playback section 107, and supplies the resultant signal to the HDMI® controller 105 via the bus.

The HDMI® controller 105 controls the HDMI® transmitting section 106 so that the AV signals supplied via the bus, i.e., the image signal from the image processor 108 and the audio signal from the audio processor 109, are supplied, and the supplied AV signals are transmitted.

The HDMI® transmitting section 106 transmits the AV signals from the HDMI® controller 105, to the AV amplifier 22 (FIG. 2) via the cable 1, as controlled by the HDMI® controller 105.

Also, the HDMI® transmitting section 106 transmits control signals instructing prohibition and execution of the conversion processing, via the cable 1, as controlled by the HDMI® controller 105. Furthermore, the HDMI® transmitting section 106 receives EDID transmitted from the AV amplifier 22 or the TV 23, via the cable 1, and supplies the received EDID to the CPU 101 via the HDMI® controller 105 and the bus.

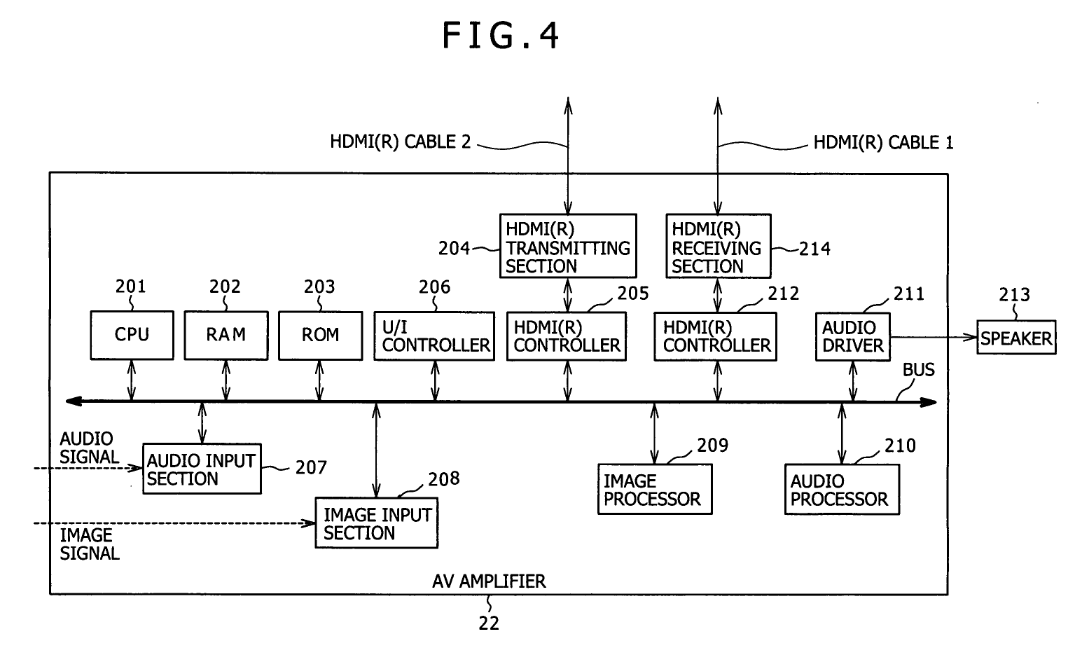

Next, FIG. 4 is a block diagram showing a configuration example of the AV amplifier 22 of FIG. 2.

The AV amplifier 22 includes a CPU 201, a RAM 202, a ROM 203, an HDMI® transmitting section 204, an HDMI® controller 205, a U/I controller 206, an audio input section 207, an image input section 208, an image processor 209, an audio processor 210, an audio driver 211, an HDMI® controller 212, and an HDMI® receiving section 214. The CPU 201, the RAM 202, and the ROM 203, and the HDMI® controller 205, the U/I controller 206, the audio input section 207, the image input section 208, the image processor 209, the audio processor 210 and the HDMI® controller 211 are mutually interconnected via a bus.

It is noted that in FIG. 4, an external speaker 213 (not shown in FIG. 2) is connected to the AV amplifier 22.

The CPU 201 executes a program stored in the ROM 203 to control over the whole of the AV amplifier 22.

Programs to be executed by the CPU 201 are loaded into the RAM 202. The RAM 202 also functions as a work area for the CPU 201. Namely, the RAM 202 stores data necessary for the CPU 201 to operate.

The ROM 203 stores a program to be executed by the CPU 201 to perform processing (control) described later.

The HDMI® transmitting section 204 transmits an AV signal to the TV 23 (FIG. 2) via the cable 2, and also transmits/receives (relays) control signals to/from the TV 23 via the cable 2, as controlled by the HDMI® controller 205.

The HDMI® controller 205 controls transmission of the AV signal, transmission/reception of the control signals, and the like in the HDMI® transmitting section 204, as controlled by the CPU 201.

The U/I controller 206 receives operational signals corresponding to user operation from a remote controller (not shown) for remote-controlling the AV amplifier 22, and operational signals inputted by the user operating operation buttons and the like provided on an operation panel (not shown) of the AV amplifier 22, and supplies these operational signals to the CPU 201.

The audio input section 207 includes an interface (e.g., an interface such as an RCA, an optical digital, or the like) for inputting an audio signal having a format different from HDMI® format, and outputs the audio signal inputted thereto, onto the bus.

The image input section 208 includes an interface (e.g., an interface such as the RCA, an analog component, or the like) for inputting an image signal having a format different from HDMI® format, and outputs the image signal inputted thereto, onto the bus.

The image processor 209 performs conversion processing and other image processing on the image signal outputted onto the bus from the image input section 208 and on an image signal among AV signals outputted from the HDMI® controller 212 onto the bus, and outputs the processed signals onto the bus.

The audio processor 210 performs encoding, decoding, sampling processing, and other audio processing on the audio signal outputted onto the bus from the audio input section 207 and on an audio signal among the AV signals outputted from the HDMI® controller 212 onto the bus, and outputs the processed signals onto the bus.

The audio driver 211 drives the speaker 213 in response to an audio signal on the bus.

The HDMI® controller 212 controls reception of an AV signal, transmission/reception of control signals, and the like in the HDMI® receiving section 214, as controlled by the CPU 201.

The speaker 213 is driven by the audio driver 211, and outputs an audio sound. It is noted that the speaker 213 is provided outside the AV amplifier 22 in FIG. 4, but that the speaker 213 may be incorporated into the AV amplifier 22.

The HDMI® receiving section 214 receives an AV signal transmitted from the DVD player 21 (FIG. 2) via the cable 1, and transmits/receives (relays) control signals to/from the DVD player 21 via the cable 1, as controlled by the HDMI® controller 212.

In the AV amplifier 22 thus configured, e.g., the HDMI® receiving section 214 receives the AV signal transmitted from the DVD player 21 via the cable 1 as described above with reference to FIG. 3, and supplies the AV signal to the image processor 209 and the audio processor 210 via the HDMI® controller 212 and the bus.

The image processor 209 performs the necessary image processing on the image signal among the AV signals from the DVD player 21, and supplies the resultant signal to the HDMI® controller 205 via the bus.

The audio processor 210 performs the necessary image processing on the audio signal among the AV signals from the DVD player 21, and supplies the resultant signal to the HDMI® controller 205 via the bus.

The HDMI® controller 205 controls the HDMI® transmitting section 204 so that the AV signals supplied via the bus, i.e., the image signal from the image processor 209 and the audio signal from the audio processor 210, are supplied, and the supplied AV signals are transmitted.

The HDMI® transmitting section 204 transmits the AV signals from the HDMI® controller 205, to the TV 23 via the cable 2, as controlled by the HDMI® controller 205.

Furthermore, the HDMI® receiving section 214 receives the control signals transmitted from the DVD player 21 via the cable 1 as described above with reference to FIG. 3, and supplies the received control signals to the CPU 201 and the HDMI® controller 205 via the HDMI® controller 212 and the bus.

Here, the CPU 201 controls execution of the conversion processing by the image processor 209, in accordance with the control signals from the DVD player 21.

Furthermore, the HDMI® receiving section 214 transmits the EDID about the TV 23 received by the HDMI® transmitting section 204 and supplied thereto from the HDMI® controller 205, the bus, and the HDMI® controller 212, and the EDID about the AV amplifier 22 stored by the HDMI® receiving section 214, to (the HDMI® transmitting section 106 (FIG. 3) of) the DVD player 21 via the cable 1.

Meanwhile, the HDMI® controller 205 supplies the control signal from the DVD player 21 to the HDMI® transmitting section 204 to transmit the supplied control signal to the TV 23.via the cable 2.

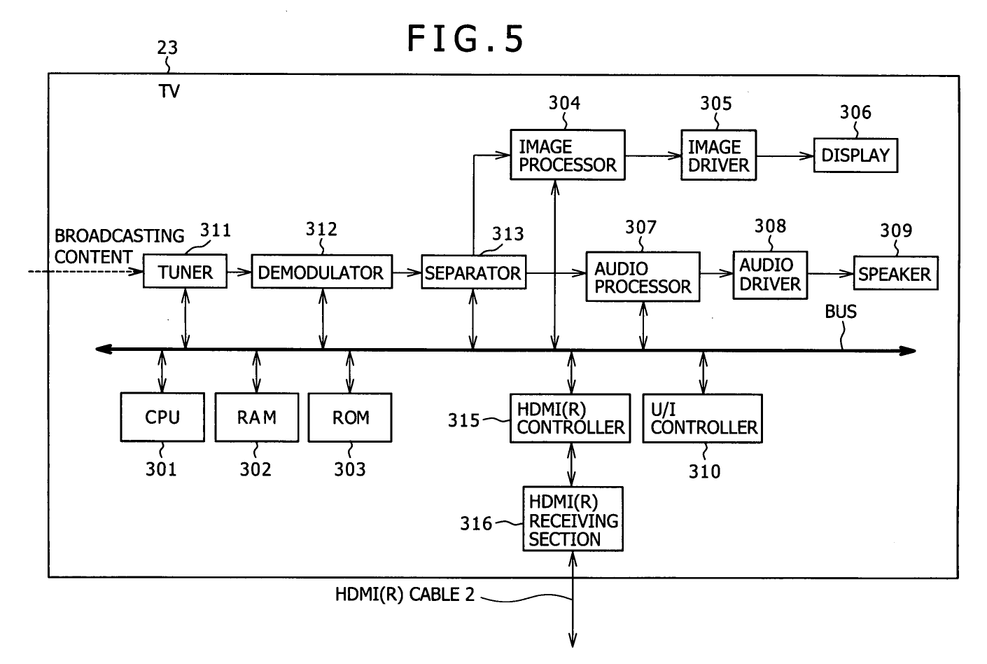

Next, FIG. 5 is a block diagram showing a configuration example of the TV 23 of FIG. 2.

The TV 23 includes a CPU 301, a RAM 302, a ROM 303, an image processor 304, an image driver 305, a display 306, an audio processor 307, an audio driver 308, a speaker 309, a U/I controller 310, a tuner 311, a demodulator 312, a separator 313, an HDMI® controller 315, and an HDMI® receiving section 316. The CPU 301, the RAM 302, the ROM 303, the image processor 304, and the audio processor 307, and the U/I controller 310, the tuner 311, the demodulator 312, the separator 313, and the HDMI® controller 315 are mutually interconnected via a bus.

The CPU 301 executes a program stored in the ROM 303 to control over the whole of the TV 23.

Programs to be executed by the CPU are loaded in the RAM 302. The RAM 302 also functions as a work area for the CPU 301. Namely, the RAM 302 stores data necessary for the CPU 301 to operate.

The ROM 303 stores a program to be executed by the CPU 301 to perform processing (control) described later.

The image processor 304 performs conversion processing and other image processing on an image signal supplied thereto from the separator 313 and an image signal among AV signals outputted from the HDMI® controller 315 onto the bus, and outputs the processed image signals to the image driver 305.

It is noted that the image processor 304 also decodes the image signal supplied from the separator 313 if the image signal is encoded (compressed) by MPEG (Moving Picture Experts Group) or other methods.

The image driver 305 performs digital-to-analog (D/A) conversion and the like on the image signals supplied thereto from the image processor 304, and drives the display 306 in response to the resultant image signals.

The display 306 is constructed of, for example, a liquid-crystal panel, an organic electro-luminescence (EL), or the like, and displays an image as driven by the image driver 305.

The audio processor 307 performs encoding, decoding, sampling processing, and other audio processing on an audio signal supplied thereto from the separator 313 and an audio signal in the AV signal outputted from the HDMI® controller 315 onto the bus, and outputs the processed signals to the audio driver 308.

It is noted that the audio processor 308 also decodes the audio signal supplied from the separator 31 if the audio signal is encoded by MPEG or other methods.

The audio driver 308 performs D/A conversion and the like on the audio signals from the audio processor 307, and drives the speaker 309 in accordance with the resultant audio signals.

The speaker 309 is driven by the audio driver 308, and outputs an audio sound.

The U/I controller 310 receives operational signals corresponding to user operation from a remote controller (not shown) for remote-controlling the TV 23, and operational signals inputted by the user operating operation buttons and the like provided on an operation panel (not shown) of the TV 23, and supplies these operational signals to the CPU 301 via the bus. These operational signals include those instructing, e.g., power-on/off, tuning by the tuner 311, image-related processing, audio-related processing, and various other processing for the TV 23.

The tuner 311 includes, for example, a digital tuner for digital broadcasting, and an analog tuner for analog broadcasting.

Here, two or more tuners 311 may be provided. Furthermore, the tuner 311 may not necessarily be an analog tuner. In the following, the tuner 311 is supposed to function as a tuner for receiving digital broadcasting.

The tuner 311 receives (tunes) a broadcasting signal of digital broadcasting which is a signal obtained by modulating an AV signal as a broadcasting program, and supplies the received modulated signal to the demodulator 312.

The demodulator 312 demodulates the modulated signal supplied from the tuner 311, further subjects the demodulated signal to error-correcting processing, frame reconstructing, and the like, and supplies the resultant data stream having the AV signal multiplexed therein, to the separator 313.

The separator 313 separates the data stream from the demodulator 312 into an image signal (image data) and an audio signal (audio data), and supplies the image signal to the image processor 304 and also the audio signal to the audio processor 307.

The HDMI® controller 315 controls reception of an AV signal, transmission/reception of control signals, and the like in the HDMI® receiving section 316, as controlled by the CPU 301.

The HDMI® receiving section 316 receives an AV signal transmitted from the AV amplifier 22 (FIG. 2) via the cable 2, and transmits/receives (relays) control signals to/from the AV amplifier 22 via the cable 2, as controlled by the HDMI® controller 315.

In the TV 23 thus configured, for example, the HDMI® receiving section 316 receives the AV signal transmitted from the DVD player 21 via the cable 1, the AV amplifier 22, and the cable 2 as described above with reference to FIGS. 3 and 4, and supplies the received AV signal to the image processor 304 and the audio processor 307 via the HDMI® controller 315 and the bus.

The image processor 304 performs the necessary image processing on the image signal among the AV signals (AV signal transmitted from the DVD player 21 via the AV amplifier 22) from the DVD player 21, and supplies the resultant image signal to the display 306 via the image driver 305, for displaying a corresponding image thereon.

The audio processor 307 performs the necessary audio processing on the audio signal among the AV signals from the DVD player 21, and supplies the resultant signal to the speaker 309 via the audio driver 308, for outputting a corresponding audio sound therefrom.

Furthermore, the HDMI® receiving section 316 receives the control signal transmitted from the DVD player 21 via the cable 1, the AV amplifier 22, and the cable 2 as described above with reference to FIGS. 3 and 4, and supplies the received control signal to the CPU 301 via the HDMI® controller 315 and the bus.

Here, the CPU 301 controls execution of the conversion processing by the image processor 304, in accordance with the control signal from the DVD player 21.

Furthermore, the HDMI® receiving section 316 transmits the EDID about the TV 23 stored by the HDMI® receiving section 316, to (the HDMI® transmitting section 204 (FIG. 4) of) the AV amplifier 22 via the cable 2.

In the DVD player 21 of FIG. 3, the programs executed by the CPU 101 can be pre-installed in the ROM 103 and, in addition, can be recorded on a removable recording medium such as a flexible disk, a CD-ROM (Compact Disc Read Only Memory), a MO (Magneto Optical) disc, a DVD, a magnetic disk, or a semiconductor memory, and then installed onto the DVD player 21 from such a removable recording medium.

Furthermore, the programs can be downloaded from a downloading site via a network such as the Internet or a LAN, and installed onto the DVD player 21.

The programs executed by the CPU 201 of the AV amplifier 22 of FIG. 4, and the programs executed by the CPU 301 of the TV 23 of FIG. 5 are downloaded and installed in the same manner as described above.

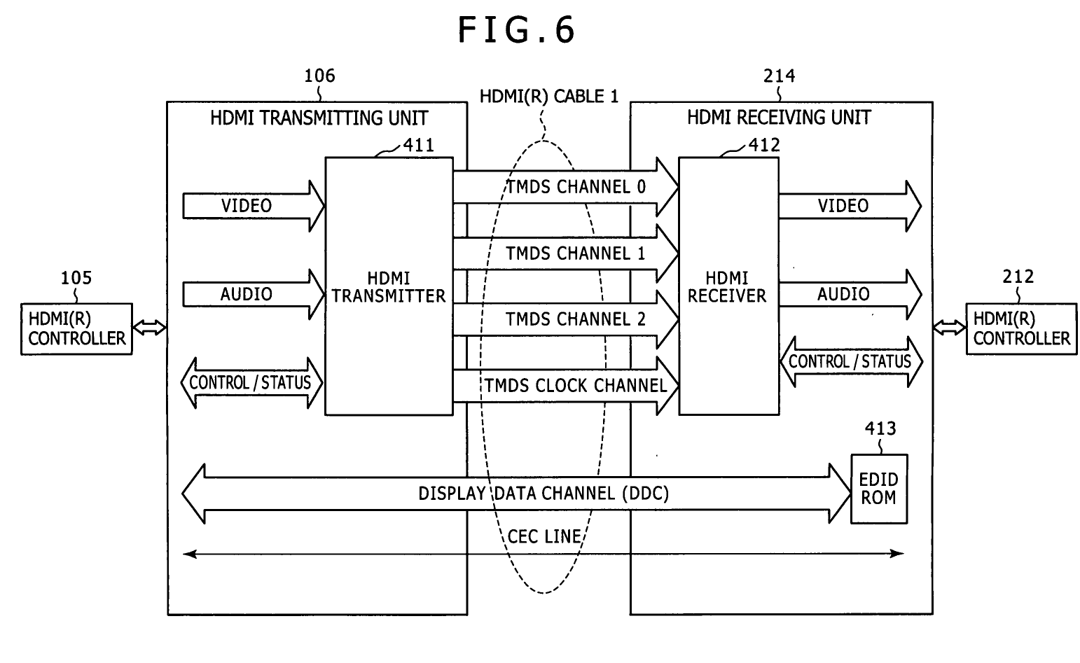

Next, FIG. 6 shows a configuration example of the HDMI® transmitting section 106 of FIG. 3 and the HDMI® receiving section 214 of FIG. 4.

In an effective image period which is a period in which a horizontal blanking period and a vertical blanking period (hereinafter called also as “active video period” as appropriate) are excluded from a period extending from one vertical synchronous signal (VSYNC) to a next VSYNC (hereinafter called as “video field” as appropriate), the HDMI® transmitting section 106 unidirectionally transmits a differential signal corresponding to a screenful of a baseband image signal (pixel values), to the HDMI® sink through a plurality of channels. Also, in the horizontal blanking period or the vertical blanking period, the HDMI® transmitting section 106 unidirectionally transmits a differential signal corresponding to at least a signal containing audio sound accompanying an image, to the HDMI® sink through the plurality of channels.

Namely, the HDMI® transmitting section 106 includes a transmitter 411. The transmitter 411 converts, for example, the baseband image signal into the corresponding differential signal. Furthermore, the transmitter 411 unidirectionally and serially transmits the differential signal corresponding to the image signal to the HDMI® receiving section 214 as the HDMI® sink connected thereto via the cable 1 through three TMDS channels #0, #1, and #2 which are the plurality of channels.

Furthermore, the transmitter 411 converts signals, such as the audio signal accompanying the baseband image and/or an auxiliary data signal, into corresponding differential signals, and unidirectionally and serially transmits the differential signals to the HDMI® receiving section 214 connected thereto via the cable 1 through the three TMDS channels #0, #1, and #2.

Furthermore, the transmitter 411 transmits a pixel clock in synchronism with the image signal transmitted through the three TMDS channels #0, #1, and #2, to the HDMI® receiving section 214 connected thereto via the cable 1, through a TMDS clock channel.

The HDMI® receiving section 214 receives the differential signal unidirectionally transmitted from the HDMI® transmitting section 106 which is the HDMI® source through the three TMDS channels #0 to #2 during the active video period, and also receives the differential signals unidirectionally transmitted from the HDMI® transmitting section 106 through the three TMDS channels #0 to #2 during the horizontal blanking period or the vertical blanking period.

Namely, the HDMI® receiving section 214 includes a receiver 412. The receiver 412 receives the differential signals unidirectionally transmitted from the HDMI® transmitting section 106 through the TMDS channels #0 to #2, in synchronism with the pixel clock similarly transmitted from the HDMI® transmitting section 106 through the TMDS clock channel.

The HDMI® transmission channels include the three TMDS channels #0 to #2 as transmission channels for unidirectionally and serially transmitting image and audio signals to the HDMI® receiving section 214 from the HDMI® transmitting section 106 in synchronism with a pixel clock, the TMDS clock channel as a transmission channel for transmitting a pixel clock, and other transmission channels called the DDC and the CEC line.

The DDC is used by the HDMI® transmitting section 106 to read EDID from the HDMI® receiving section 214.

Namely, the HDMI® receiving section 214 includes an EDIDROM 413 storing the EDID (E-EDID) which is information about the configuration and capability of the AV amplifier 22, in addition to the receiver 412. The HDMI® transmitting section 106 reads the EDID about the AV amplifier 22 stored in the EDIDROM 413 of the HDMI® receiving section 214, from the HDMI® receiving section 214 via the DDC, and recognizes the configuration and capability of the AV amplifier 22 on the basis of the EDID, i.e., it recognizes, for example, formats such as image resolutions that the AV amplifier 22 being the HDMI® apparatus including the HDMI® receiving section 214 is able to output (is supporting). The CEC line is used to perform bidirectional communication of control signals between the HDMI® transmitting section 106 and the HDMI® receiving section 214.

The HDMI® transmitting section 106 and the HDMI® receiving section 214 are connected via the cable 1, i.e., wired in FIG. 6. However, the HDMI® transmitting section 106 and the HDMI® receiving section 214 may be connected wirelessly.

Furthermore, the HDMI® transmitting section 204 of FIG. 4 and the HDMI® receiving section 316 of FIG. 5 are also configured similarly to the HDMI® transmitting section 106 and the HDMI® receiving section 214 shown in FIG. 6, respectively.

In the AV amplifier 22 (FIG. 4), the HDMI® transmitting section 204 reads the EDID about the TV 23 from the TV 23 similarly to the HDMI® transmitting section 106 of the DVD player 21. Furthermore, in the AV amplifier 22 (FIG. 4), the HDMI® receiving section 214 transmits the EDID about the TV 23 read by the HDMI® transmitting section 204, to the DVD player 21 via the DDC, so that (the CPU 101 of) the DVD player 21 recognizes formats such as image resolutions which the display 306 of the TV 23 is able to display.

By the way, the DVD player 21, the AV amplifier 22, and the TV 23 of FIG. 2 are conversion-capable apparatus all capable of performing the conversion processing as described above. However, each of the DVD player 21, the AV amplifier 22, and the TV 23 being conversion-capable apparatus has processing modes, which are an auto mode, a manual mode, and a select mode for the conversion processing.

Here, if all the conversion-capable apparatus are set to the auto mode, the HDMI® source among the conversion-capable apparatuses converts an image signal into a signal having the highest resolution supported by the HDMI® sink, and the resultant image signal is outputted.

In a conversion-capable apparatus set to the manual mode, a specified resolution is selected from a plurality of resolutions supported by the conversion-capable apparatus, in response to user operation, and an image signal is converted into an image signal having the specified resolution, and the resultant image signal is outputted.

If, e.g., the HDMI® source among the conversion-capable apparatuses is set to the select mode, one conversion-capable apparatus for performing the conversion processing is selected irrespective of any processing mode set to the other conversion-capable apparatus, and the conversion processing is performed by the one conversion-capable apparatus.

In a conversion-capable apparatus, the processing modes can be switched by operating a button (hereinafter called also “format button”) for switching image signal formats from which the conversion-capable apparatus, e.g., the remote controllers or the like which is not shown, outputs.

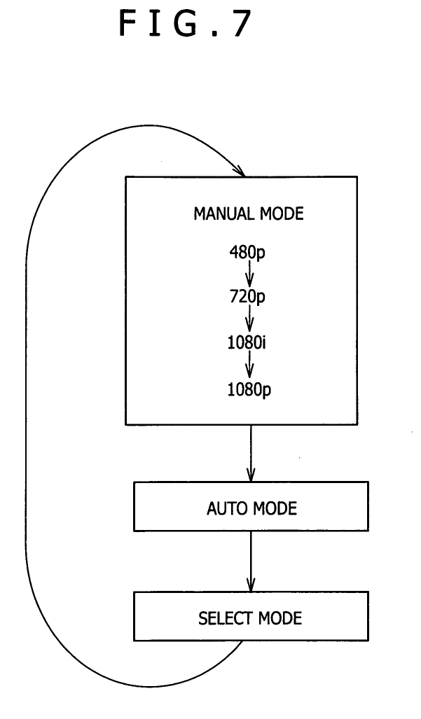

FIG. 7 shows a processing mode transition made by operating the format button.

As described above, the processing modes include the manual mode, the auto mode, and the select mode.

Furthermore, in FIG. 7, the manual mode includes a 480p mode, 720p mode, 1080i mode, and 1080p mode. In the 480p mode, an image signal format from which a conversion-capable apparatus outputs is set to 480p which is a progressive mode having 480-line horizontal scanning lines. In the 720p mode, the format is set to 720p. In the 1080i mode, the format is set to 1080i. In the 1080p mode, the format is set to 1080p which is a progressive mode having 1080-line horizontal scanning lines.

For example, when the format button is operated (e.g., pressed) only once in the 480p mode as the processing mode, the processing mode is switched to the 720p mode. From then on, every time the format button is operated, the processing mode is switched in turn to the 1080i mode and then to the 1080p mode.

Then, when the operation mode is the 1080p mode, in response to an operation of the format button, the processing mode is switched to the auto mode. When the format button is further operated, the processing mode is switched to the select mode.

When the processing mode is the select mode, in response to an operation of the format button, the processing mode returns to the 480p mode in the manual mode, and from then on, every time the format button is operated, the processing mode is similarly switched.

As described above, in the select mode, an executing apparatus, i.e., a single conversion-capable apparatus which performs the conversion processing is selected, and the conversion processing is performed in the single conversion-capable apparatus.

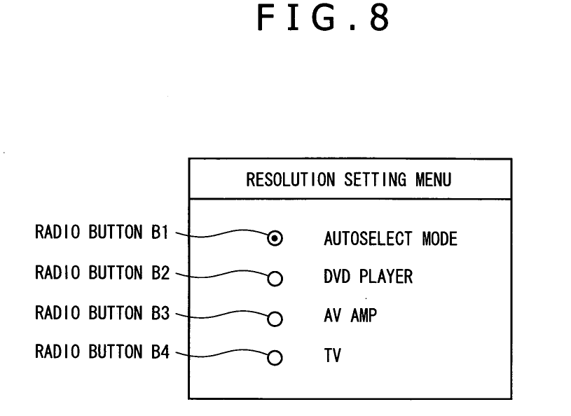

FIG. 8 shows a resolution setting menu as a menu for selecting the executing apparatus in the select mode.

For example, when the processing mode is switched to the select mode, the DVD player 21 (FIG. 2) controls the TV 23 via the AV amplifier 22, thereby causing the display 306 to display the resolution setting menu.

Namely, (the CPU 101 (FIG. 3) of) the DVD player 21 obtains the EDID about the AV amplifier 22 and the TV 23, and recognizes that the AV amplifier 22 and the TV 23 are conversion-capable apparatus (controlled conversion-capable apparatus) on the basis of the EDID.

Then, the DVD player 21 generates a resolution setting menu for the user to select one of the conversion-capable apparatus including the DVD player 21 itself, or a later-described autoselect mode, and causes the TV 23 to display the generated menu.

In the current case, the conversion-capable apparatus are three HDMI® apparatuses, which are the DVD player 21, the AV amplifier 22, and the TV 23. Accordingly, the TV 23 displays the resolution setting menu for selecting one of the three HDMI® apparatuses or the autoselect mode.

FIG. 8 shows the resolution setting menu displayed on the TV 23 in the above way.

In the resolution setting menu of FIG. 8, four radio buttons B1, B2, B3, and B4 are displayed in the vertical direction. Further, the characters “AUTOSELECT MODE” representing the autoselect mode, “DVD PLAYER” representing the DVD player 21, “AV AMP” representing the AV amplifier 22, and “TV” representing the TV 23 are displayed on the right sides of the radio buttons of B1, B2, B3, and B4, respectively.

When the radio button B1 is operated (clicked), the executing apparatus for the autoselect mode is selected. In the selection of the executing apparatus for the autoselect mode, the executing apparatus is selected on the basis of level information indicating the superiority of inferiority of the conversion processing performed by conversion-capable apparatus, details of which will be described later.

When the radio button B2 is operated, the DVD player 21 is selected as the executing apparatus. Similarly, when the radio button B3 is selected, the AV amplifier 22 is selected as the executing apparatus, and when the radio button B4 is selected, the TV 23 is selected as the executing apparatus.

Next, there will be described about processing performed by the DVD player 21 as the HDMI® source, the AV amplifier 22 as the HDMI® repeater, and the TV 23 as the HDMI® sink when the DVD player 21 causes the TV to display an image reproduced from a DVD of the DVD player 21 in the AV system of FIG. 2.

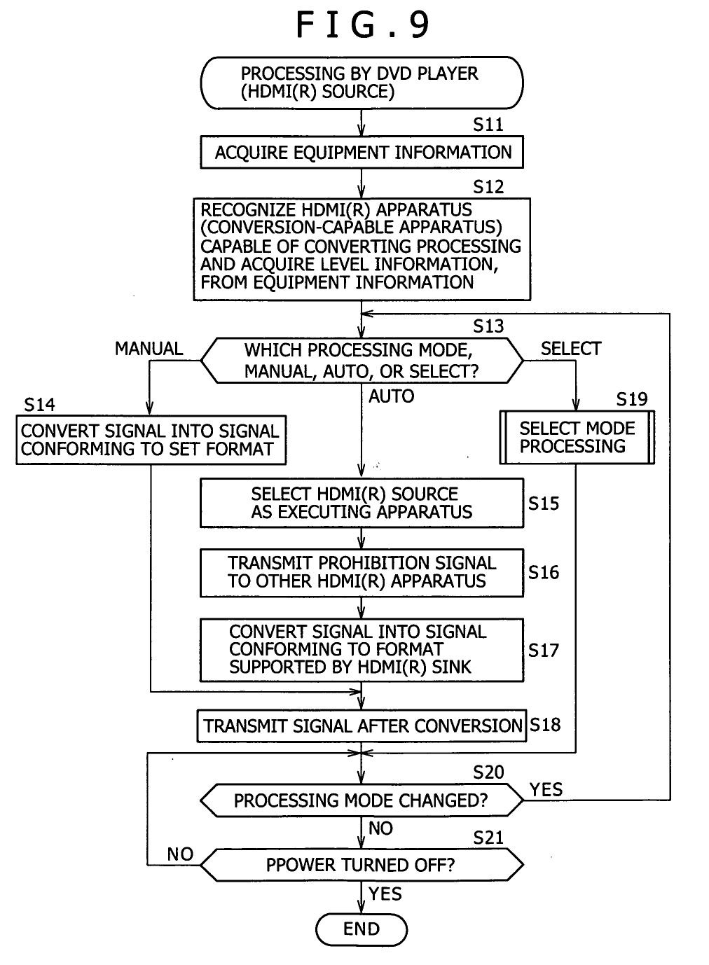

Referring first to FIG. 9, processing by the DVD player 21 as the HDMI® source will be described.

FIG. 9 is a flowchart illustrating the processing by the DVD player 21.

(The CPU 101 of) the DVD player 21, for example, in response to turn on the power, makes, in step S11, a request for equipment information to the HDMI® apparatus connected directly or indirectly thereto via the HDMI®, i.e., the AV amplifier 22 and the TV 23 in the present embodiment, and obtains the information.

Namely, the DVD player 21 obtains the information by making a request to the AV amplifier 22 and the TV 23 for their EDID, and receiving the EDID transmitted from the AV amplifier 22 and the EDID transmitted from the TV 23 via the AV amplifier 22, in response to the request.

Here, the EDID about an HDMI® apparatus includes equipment information about the HDMI® apparatus, such as a brand and a model number of the HDMI® apparatus, and image signal formats (e.g., image resolutions and the like) supported by the HDMI® apparatus.

Furthermore, the equipment information about the HDMI® apparatus also includes capable/incapable information representing whether the HDMI® apparatus is capable of performing conversion processing for converting an image signal format.

The DVD player 21 obtains the equipment information about the AV amplifier 22 and the TV 23 in step S11, and then the processing proceeds to step S12 wherein the DVD player 21 recognizes any conversion-capable apparatus by referring to the capable/incapable information contained in the equipment information about the AV amplifier 22 and the TV 23 obtained in step S11.

Here, as described above, in the present embodiment, the DVD player 21, the AV amplifier 22, and the TV 23 are all conversion-capable apparatus, and accordingly, in step S12, the DVD player 21 recognizes that all of the DVD player 21, the AV amplifier 22, and the TV 23 are conversion-capable apparatus.

Furthermore, in step S12, the DVD player 21 obtains level information about all the conversion-capable apparatus, and then the processing proceeds to step S13.

Here, the level information means information on superiority or inferiority of the conversion processing in a case where each HDMI® apparatus is a conversion-capable apparatus, i.e., in a case where the HDMI® apparatus is capable of performing the conversion processing for converting an image signal format. The level information can be contained in EDID (equipment information of EDID, or other information other than the equipment information). Furthermore, as described later, the level information can also be contained in the ROM of each apparatus.

In this case, the DVD player 21 as the HDMI® source can obtain level information by obtaining EDID about a conversion-capable apparatus. Furthermore, if the level information is contained in the ROM of the conversion-capable apparatus, the level information can also be obtained via the CEC line of the HDMI® or the like.

Furthermore, the DVD player 21 as the HDMI® source may obtain the level information by, for example, downloading from an external network such as a site in the Internet. Moreover, if the DVD player 21 includes an interface for inserting an external memory such as a memory stick®, an SD card, a USB memory, or the like, the DVD player 21 can also obtain the level information via the interface (omitted in FIG. 3) for the external memory.

Namely, for example, if the manufacturer of a conversion-capable apparatus makes public (provides) level information about the conversion processing performed by the conversion-capable apparatus at a site of the Internet by association with a model number specifying the conversion-capable apparatus, the DVD player 21 as the HDMI® source can obtain the level information associated with the model number contained in equipment information obtained from the conversion-capable apparatus, by downloading from the site of the Internet via the network interface (a description of which is omitted in FIG. 3).

It is noted that the level information about a conversion-capable apparatus represents the superiority or inferiority of the conversion processing. The superiority of inferiority can be defined by, e.g., the manufacturer. For example, the level information may be defined such that the conversion processing to be performed by any newer model of the conversion-capable apparatus is superior.

In step S13, the DVD player 21 determines which of the manual mode, the auto mode, or the select mode is set as its own processing mode.

If it is determined in step S13 that the DVD player 21 is set to the manual mode, the processing proceeds to step S14, wherein, in the DVD player 21 (FIG. 3), the CPU 101 controls the image processor 108 to convert an image signal reproduced by the DVD playback section 107 into an image signal having a format set in the manual mode. Then, the processing proceeds to step S18.

Namely, in the manual mode, as shown above in, for example, FIG. 7, the image signal format can be set to any one of the plurality of formats such as 480p, 720p, and the like. In step S14, the image processor 108 converts the image signal reproduced by the DVD playback section 107 into an image signal having a format (hereinafter called “set format” as appropriate) set in the manual mode.

Meanwhile, if it is determined in step S13 that the auto mode is set to the DVD player 21, the processing proceeds to step S15 wherein the DVD player 21 selects the DVD player 21 itself as the executing apparatus, and then after which the processing proceeds to step S16.

In step S16, the DVD player 21 transmits a control signal (hereinafter called “prohibition signal” as appropriate) instructing prohibition of execution of the conversion processing, to controlled conversion-capable apparatus, i.e., all conversion-capable apparatus excluding the DVD player 21 itself, which are the AV amplifier 22 and the TV 23 in the present embodiment. Then, the processing proceeds to step S17.

Namely, in the DVD player 21 (FIG. 3), the CPU 101 controls the HDMI® transmitting section 106 via the HDMI® controller 105, to transmit the prohibition signal to the AV amplifier 22 and the TV 23 via the CEC line (FIG. 6) of the HDMI®.

In step S17, the DVD player 21 recognizes an image signal format (hereinafter called “supported format” as appropriate) supported by the TV 23 as the HDMI® sink, from the equipment information about the TV 23 obtained in the step S11.

Furthermore, in step S17, the DVD player 21 selected as the executing apparatus converts the image signal reproduced by the DVD playback section 107 into an image signal having the supported format in the image processor 108 (FIG. 3), and then the processing proceeds to step S18.

In step S18, the DVD player 21 transmits the image signal after the conversion in which the format has been converted in the image processor 108, to the AV amplifier 22 from the HDMI® transmitting section 106 via the HDMI® TMDS channels #0 to #2, and then the processing proceeds to step S20.

Meanwhile, if it is determined in step S13 that the processing mode of the DVD player 21 itself is set to the select mode, the processing proceeds to step S19 wherein the DVD player 21 performs later-described select-mode processing, and then the processing proceeds to step S20.

In step S20, the DVD player 21 determines whether the user has changed the processing mode of the DVD player 21 itself. If it is determined in step S20 that the processing mode of the DVD player 21 itself has been changed, the processing returns to step S13, and repeats similar processing from this step forward.

Meanwhile, if it is determined in step S20 that the processing mode of the DVD player 21 itself has not been changed, the processing proceeds to step S21 wherein the DVD player 21 determines whether the user has performed an operation (off operation) of turning off the power.

If it is determined in step S21 that the off operation has not been performed, the processing returns to step S20, and repeats similar processing from this step forward.

Meanwhile, if it is determined in step S21 that the off operation has been performed, the power of the DVD player 21 is turned off, thereby terminating the processing.

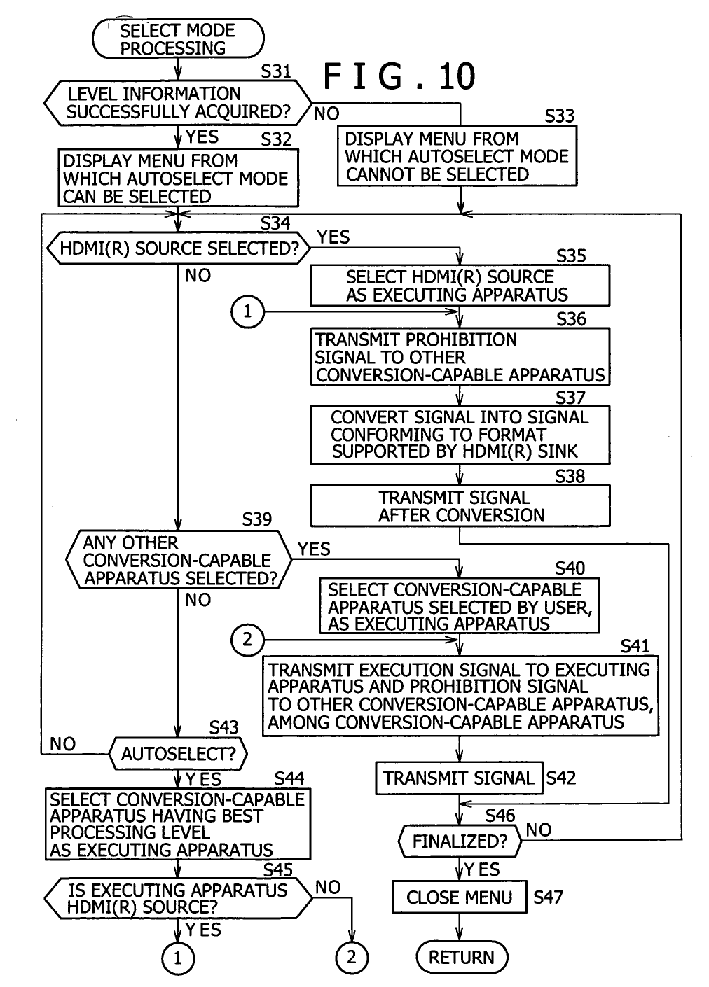

Referring next to FIG. 10, the select-mode processing performed in step S19 of FIG. 9 will be described.

In the select mode processing, it is determined in step S31 whether the DVD player 21 has successfully obtained level information about all the conversion-capable apparatus.

If it is determined in step S31 that the DVD player 21 has successfully obtained the level information about all the conversion-capable apparatus, i.e., when the DVD player 21 has successfully obtained the level information about all of the DVD player 21, the AV amplifier 22, and the TV 23 in the present embodiment, the processing proceeds to step S32 wherein the DVD player 21 controls the TV 23 via the AV amplifier 22 to display the resolution setting menu (FIG. 8) from which the autoselect mode is selected, and then the processing proceeds to step S34.

Meanwhile, if it is determined in step S31 that level information about at least a part of the conversion-capable apparatus has not successfully obtained, i.e., e.g., when any of the DVD player 21, the AV amplifier 22, and the TV 23 has its level information not made public by its manufacturer and thus the DVD player 21 has not successfully obtained the level information about that conversion-capable apparatus, the processing proceeds to step S33 wherein the DVD player 21 controls the TV 23 via the AV amplifier 22, to display the resolution setting menu (FIG. 8) indicating a state in which the autoselect mode cannot be selected, and then the processing proceeds to step S34.

Here, the state in which the autoselect mode cannot be selected means a state in which the radio button B1 for selecting the autoselect mode is displayed in a so-called “grayed out” manner, or in which the user cannot select the radio button B1 due to the character “AUTOSELECT MODE” not being displayed, in the resolution setting menu (FIG. 8).

In step S34, the DVD player 21 determines whether the user has selected the DVD player 21 which is the HDMI® source from the resolution setting menu (FIG. 8).

If it is determined in step S34 that the user has selected the DVD player 21 which is the HDMI® source from the resolution setting menu, i.e., when the user has operated the radio button B₂ of the resolution setting menu (FIG. 8), the processing proceeds to step S35 wherein the DVD player 21 selects the DVD player 21 itself as the executing apparatus, and then the processing proceeds to step S36.

In step S36, the DVD player 21 transmits the prohibition signal to the controlled conversion-capable apparatus, i.e., all conversion-capable apparatus excluding the DVD player 21 itself, which are the AV amplifier 22 and the TV 23 in the present embodiment, and then the processing proceeds to step S37.

Namely, in the DVD player 21 (FIG. 3), the CPU 101 controls the HDMI® transmitting section 106 via the HDMI® controller 105, to transmit the prohibition signal to the AV amplifier 22 and the TV 23 via the CEC line of the HDMI® (FIG. 6).

In step S37, the DVD player 21 recognizes the supported format of the TV 23 as the HDMI® sink, from the equipment information about the TV 23 obtained in the step S11 of FIG. 9.

Furthermore, in step S37, the DVD player 21 selected as the executing apparatus causes the image processor 108 (FIG. 3) to convert the image signal reproduced by the DVD playback section 107 into an image signal having the supported format, and then the processing proceeds to step S38.

In step S38, the DVD player 21 transmits the image signal after the conversion obtained by converting the format in the image processor 108, to the AV amplifier 22 from the HDMI® transmitting section 106 via the HDMI® TMDS channels #0 to #2.

Meanwhile, if it is determined in step S34 that the user has not selected the DVD player 21 which is the HDMI® source from the resolution setting menu, the processing proceeds to step S39 wherein the DVD player 21 determined whether the user has selected any controlled conversion-capable apparatus (the AV amplifier 22 or the TV 23 in the present embodiment) which is any conversion-capable apparatus excluding the DVD player 21 being the HDMI® source, from the resolution setting menu (FIG. 8).

If it is determined in step S39 that the user has selected any controlled conversion-capable apparatus (the AV amplifier 22 or the TV 23 in the present embodiment), i.e., when the user has operated the radio button B₃ or B₄ of the resolution setting menu (FIG. 8), the processing proceeds to step S40 wherein the DVD player 21 selects the controlled conversion-capable apparatus selected by the user as the executing apparatus, and then the processing proceeds to step S41.

In step S41, the DVD player 21 recognizes the supported format of the TV 23 as the HDMI® sink, from the equipment information about the TV 23 obtained in the step S11 of FIG. 9.

Furthermore, in step S41, the DVD player 21 transmits a control signal (hereinafter called “execution signal” as appropriate) instructing execution of the conversion processing for performing conversion into an image signal having the supported format, to the executing apparatus among the controlled conversion-capable apparatuses, and also transmits the prohibition signal to any of the controlled conversion-capable apparatus which is not the executing apparatus, and then the processing proceeds to step S42.

Namely, in the DVD player 21 (FIG. 3), the CPU 101 controls the HDMI® transmitting section 106 via the HDMI® controller 105, to transmit the execution signal to the executing apparatus which is one of the AV amplifier 22 and the TV 23, and the prohibition signal to the other apparatus, via the CEC line of the HDMI® (FIG. 6).

In step S42, the DVD player 21 which is not selected as the executing apparatus transmits the image signal reproduced by the DVD playback section 107 without converting the format, to the AV amplifier 22 from the HDMI® transmitting section 106 via the TMDS channels #0 to #2 of the HDMI®.

Meanwhile, if it is determined in step S39 that the user has not selected the controlled conversion-capable apparatus, the processing proceeds to step S43 wherein the DVD player 21 determines whether the user has selected the autoselect mode from the resolution setting menu (FIG. 8).

Here, if, in step S33, the resolution setting menu has been displayed which is in the state in which the autoselect mode cannot be selected, and when it is determined in step S39 that the user has not selected any controlled conversion-capable apparatus, the processing returns to step S34 by skipping step S43.

If it is determined in step S43 that the user has not selected the autoselect mode, the processing returns to step S34.

Meanwhile, if it is determined in step S43 that the user has selected the autoselect mode, i.e., when the user has operated the radio button B₁ of the resolution setting menu (FIG. 8), the processing proceeds to step S44 wherein the DVD player 21 selects a conversion-capable apparatus which performs the most superior conversion processing as the executing apparatus on the basis of the level information obtained in the step S12 of FIG. 9, and then the processing proceeds to step S45.

Namely, it is supposed, for example, that there are three conversion processing levels A, B, and C in which A is superior to B, and B is superior to C. It is also supposed that the level information about the DVD player 21 indicates the level B, the level information about the AV amplifier 22 indicates the level A, and the level information about the TV 23 indicates the level C. Then, the AV amplifier 22 whose level information indicates the level A is selected as the executing apparatus.

In step S45, the DVD player 21 determines whether the executing apparatus is the DVD player 21 itself which is the HDMI® source.

If it is determined in step S45 that the executing apparatus is the HDMI® source, the processing proceeds to step S36, and then the processing is performed from this step forward, which is similar to the case where the DVD player 21 being the HDMI® source has been selected as the executing apparatus in step S35.

Meanwhile, if it is determined in step S45 that the executing apparatus is not the HDMI® source, i.e., when the executing apparatus is a controlled conversion-capable apparatus, the processing proceeds to step S41, and then the processing is performed from this step forward, which is similar to the case where the controlled conversion-capable apparatus has been selected as the executing apparatus in step S40.

Then, after the DVD player 21 has transmitted the image signal to the AV amplifier 22 in step S38 or S42, the processing proceeds to step S46 in either of these cases. Consequently, the DVD player 21 determines whether the user has performed an operation (confirming operation) confirming the executing apparatus.

If it is determined in step S46 that the confirming operation has not been performed, the processing returns to step S34, and repeats similar processing from this step forward.

Meanwhile, if it is determined in step S46 that the confirming operation has been performed, the processing proceeds to step S47 wherein the DVD player 21 controls the TV 23 via the AV amplifier 22, to close (delete) the resolution setting menu (FIG. 8) displayed in step S32 or S33, and then the processing returns.

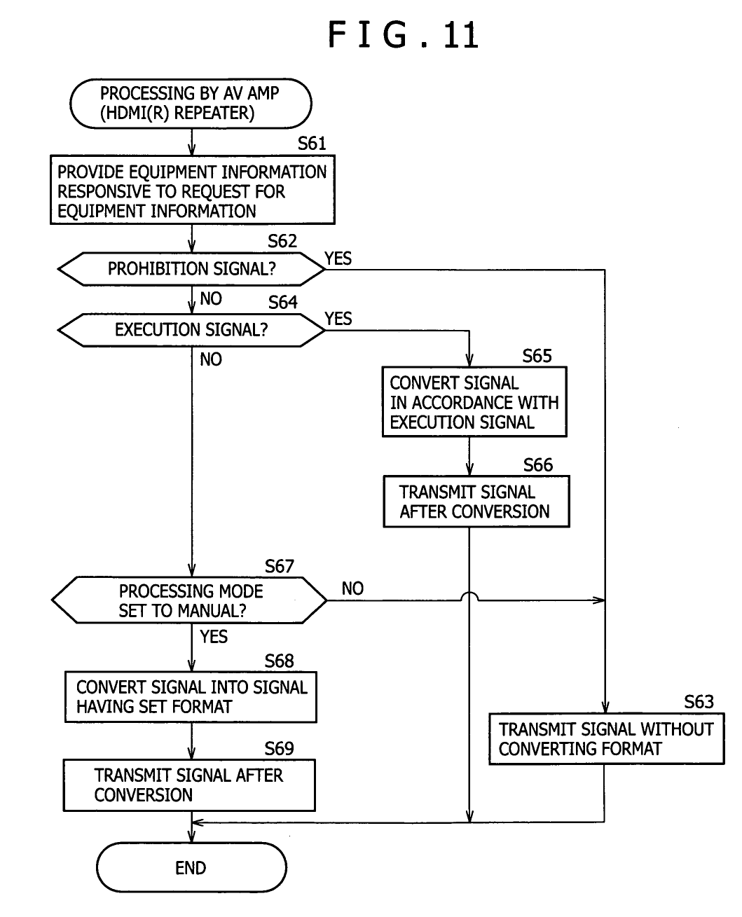

Next, FIG. 11 is a flowchart illustrating processing by the AV amplifier 22 as the HDMI® repeater.

When (the CPU 201 of) the AV amplifier 22, for example, in response to turn on the power, provides, in step S61, the EDID about the AV amplifier 22 by transmission to the DVD player 21, after receiving a request for the EDID from the DVD player 21 which is the HDMI® source, and then the processing proceeds to step S62.

In step S62, the AV amplifier 22 determines whether the prohibition signal addressed to the AV amplifier 22 has been transmitted from the DVD player 21 which is the HDMI® source.

If it is determined in step S62 that the prohibition signal has been transmitted, i.e., when the HDMI® receiving section 214 has received the prohibition signal (addressed to the AV amplifier 22) via the CEC line of the HDMI® (FIG. 6) in the AV amplifier 22 (FIG. 4), the processing proceeds to step S63 wherein the AV amplifier 22 controls the image processor 209 not to perform the conversion processing, and also transmits an image signal transmitted from the DVD player 21 to the TV 23 without converting the format, whereby the processing is terminated.

Namely, in the AV amplifier 22 (FIG. 4), the image signal transmitted from the DVD player 21 via the TMDS channels #0 to #2 of the HDMI® is received by the HDMI® receiving section 214, and supplied to the HDMI® transmitting section 204 via the HDMI® controller 212 and the HDMI® controller 205.

Then, the HDMI® transmitting section 204 transmits the image signal from the DVD player 21 to the TV 23 via the TMDS channels #0 to #2 of the HDMI®.

Meanwhile, if it is determined in step S62 that the prohibition signal has not been transmitted, the processing proceeds to step S64 wherein the AV amplifier 22 determines whether the execution signal addressed to the AV amplifier 22 has been transmitted from the DVD player 21 which is the HDMI® source.

If it is determined in step S64 that the execution signal has been transmitted, i.e., when the HDMI® receiving section 214 has received the execution signal (addressed to the AV amplifier 22) via the CEC line of the HDMI® (FIG. 6) in the AV amplifier 22 (FIG. 4), the processing proceeds to step S65 wherein the AV amplifier 22 controls the image processor 209 to perform conversion processing for converting the image signal transmitted from the DVD player 21 into an image signal having a format compliant with the execution signal, and then the processing proceeds to step S66.

Namely, in the AV amplifier 22 (FIG. 4), the image signal transmitted from the DVD player 21 via the HDMI® TMDS channels #0 to #2 is received by the HDMI® receiving section 214, and supplied to the image processor 209 via the HDMI® controller 212.

The image processor 209 converts the image signal from the DVD player 21 into the image signal having the format compliant with the execution signal, and supplies the image signal after the conversion to the HDMI® transmitting section 204 via the HDMI® controller 205.

In step S66, the AV amplifier 22 transmits the image signal after the conversion, whose format has been converted by the image processor 209, to the TV 23 from the HDMI® transmitting section 204 via the HDMI® TMDS channels #0 to #2, thereby terminating the processing.

Meanwhile, if it is determined in step S64 that the execution signal has not been transmitted, i.e., when neither the prohibition signal nor the execution signal has been transmitted to the AV amplifier 22 from the DVD player 21, the processing proceeds to step S67 wherein the AV amplifier 22 determines whether the processing mode of the AV amplifier 22 itself is set to the manual mode.

If it is determined in step S67 that the processing mode of the AV amplifier 22 itself is not set to the manual mode, i.e., when the processing mode of the AV amplifier 22 itself is set to either the auto mode or the select mode, the processing proceeds to step S63, and then processing similar to the above-mentioned case is performed from this step forward.

Meanwhile, if it is determined in step S67 that the processing mode of the AV amplifier 22 itself is set to the manual mode, the processing proceeds to step S68 wherein the CPU 201 controls the image processor 209 in the AV amplifier 22 (FIG. 4), to convert the image signal transmitted from the DVD player 21 and received by the HDMI® receiving section 214 into an image signal having a format set in the manual mode, and then the processing proceeds to step S69.

Namely, in the manual mode, as shown above in FIG. 7, the image signal can be set to any one of the plurality of formats such as 480p and 720p. In step S68, the image signal from the DVD player 21 is converted into the image signal having the format (set format) set by the manual mode in the image processor 209.

In step S69, the AV amplifier 22 transmits the image signal after the conversion whose format has been converted by the image processor 209, to the TV 23 from the HDMI® transmitting section 204 via the TMDS channels #0 to #2 of the HDMI®, thereby terminating the processing.

As described above, the AV amplifier 22, when the prohibition signal or the execution signal has been transmitted from the DVD player 21, controls execution of the conversion processing in accordance with the prohibition signal or the execution signal from the DVD player 21, irrespective of any processing modes.

If the processing mode of the AV amplifier 22 is set to the manual mode of the AV amplifier 22 itself, it may be possible to convert the image signal from the DVD player 21 into an image signal having a set format set in the manual mode of the AV amplifier 22 itself, irrespective of the prohibition signal and the execution signal from the DVD player 21.

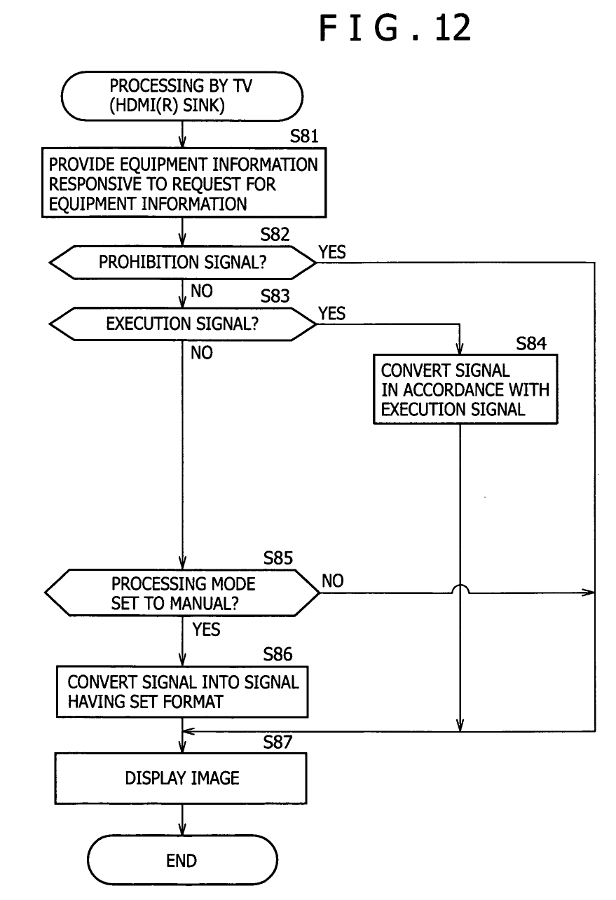

Next, FIG. 12 is a flowchart illustrating processing by the TV 23 as the HDMI® sink.

When (the CPU 301 of) the TV 23, for example, in response to turn on the power, provides, in step S81, the EDID about the TV 23 by transmission to the DVD player 21, after receiving a request for the EDID from the DVD player 21 which is the HDMI® source, and then the processing proceeds to step S82.

In step S82, the TV 23 determines whether the prohibition signal addressed to the TV 23 has been transmitted from the DVD player 21 which is the HDMI® source.

If it is determined in step S82 that the prohibition signal has been transmitted, i.e., when the HDMI® receiving section 316 has received the prohibition signal (addressed to the TV 23) via the CEC line of the HDMI® (FIG. 6) in the TV 23 (FIG. 5), the TV 23 controls the image processor 304 not to perform the conversion processing, and then the processing proceeds to step S87.

Namely, in the TV 23 (FIG. 5), the image signal transmitted from the DVD player 21 via the AV amplifier 22 and the TMDS channels #0 to #2 of the HDMI® is received by the HDMI® receiving section 316, and supplied to the image processor 304 via the HDMI® controller 315.

The image processor 304 does not perform conversion processing on the image signal supplied from the HDMI® receiving section 316 via the HDMI® controller 315, but supplies the image signal to the image driver 305.

Meanwhile, if it is determined in step S82 that the prohibition signal has not been transmitted, the processing proceeds to step S83 wherein the TV 23 determines whether the execution signal addressed to the TV 23 has been transmitted from the DVD player 21 which is the HDMI® source via the AV amplifier 22.

If it is determined in step S83 that the execution signal has been transmitted, i.e., when the HDMI® receiving section 316 has received the execution signal (addressed to the TV 23) via the CEC line of the HDMI® (FIG. 6) in the TV 23 (FIG. 5), the processing proceeds to step S84 wherein the TV 23 controls the image processor 304 to perform the conversion processing for converting the image signal transmitted from the DVD player 21 into an image signal having a format compliant with the execution signal, and then the processing proceeds to step S87.

Namely, in the TV 23 (FIG. 5), the image signal transmitted from the DVD player 21 via the AV amplifier 22 and the TMDS channels #0 to #2 of the HDMI® is received by the HDMI® receiving section 316, and supplied to the image processor 304 via the HDMI® controller 315.

The image processor 304 converts the image signal supplied from the DVD player 21 into the image signal having the format compliant with the execution signal, and supplies the converted image signal to the image driver 305.

Meanwhile, if it is determined in step S83 that the execution signal has not been transmitted, i.e., when neither the prohibition signal nor the execution signal has been transmitted to the TV 23 from the DVD player 21, the processing proceeds to step S85 wherein the TV 23 determines whether the processing mode of the TV 23 is set to the manual mode.

If it is determined in step S85 that the processing mode is not set to the manual mode, i.e., when the processing mode is set to either the auto mode or the select mode, the processing proceeds to step S87 by skipping step S86.

In this case, in the TV 23 (FIG. 5), the image signal transmitted from the DVD player 21 via the AV amplifier 22 and the TMDS channels #0 to #2 of the HDMI® is received by the HDMI® receiving section 316, and supplied to the image processor 304 via the HDMI® controller 315.

The image processor 304 does not performs conversion processing on the image signal supplied from the HDMI® receiving section 316 via the HDMI® controller 315, but supplies the image signal to the image driver 305.

Meanwhile, if it is determined in step S85 that the processing mode is set to the manual mode, the processing proceeds to step S86 wherein the CPU 301 controls the image processor 304 in the TV 23 (FIG. 5) to convert the image signal transmitted from the DVD player 21 and received by the HDMI® receiving section 316 via the AV amplifier 22, into an image signal having a format set in the manual mode, and then the processing proceeds to step S87.

Namely, in the manual mode, for example, as shown in FIG. 7, the image signal can be set to any one of the plurality of formats such as 480p and 720p. In step S86, the image signal from the DVD player 21 is converted into the image signal having the format (set format) set in the manual mode, and the converted image signal is supplied to the image processor 304.

In step S87, in the TV 23, the image driver 305 drives the display 306 in the TV 23, thereby displaying an image corresponding to the image signal from the image processor 304, and then the processing is terminated.

As described above, even in the TV 23, similarly to the AV amplifier 22, when the prohibition signal or the execution signal has been transmitted from the DVD player 21, the execution of conversion processing is controlled in accordance with the prohibition signal or the execution signal from the DVD player 21, irrespective of any processing modes.

It is noted that in the TV 23, if the format of the image signal received by the HDMI® receiving section 316 is not a supported format (image format displayable by the display 306) supported by the TV 23, the image processor 304 converts the image signal into an image signal having the supported format, and supplies the converted image signal to the image driver 305.

Furthermore, in the TV 23, if the processing mode of the TV 23 is the manual mode of the TV 23 itself, it may be possible to convert the image signal supplied from the DVD player 21 via the AV amplifier 22 into an image signal having a set format set in the manual mode of the TV 23 itself, irrespective of the prohibition signal and the execution signal from the DVD player 21.

As described above, the DVD player 21 which is the HDMI® source obtains the equipment information about the AV amplifier 22 and the TV 23 connected thereto via the HDMI®, which contains at least capable/incapable information representing whether the apparatus is capable of performing the conversion processing, and recognizes that the DVD player 21, the AV amplifier 22, and the TV 23 are conversion-capable apparatus.

Furthermore, the DVD player 21 selects one of the conversion-capable apparatuses as an executing apparatus in the select mode. If the executing apparatus is the DVD player 21, the DVD player 21 instructs all the controlled conversion-capable apparatus (AV amplifier 22 and the TV 23) of the conversion-capable apparatus to prohibit the conversion processing, via the CEC line. If the executing apparatus is one of the controlled conversion-capable apparatuses, the DVD player 21 instructs the executing apparatus of the controlled conversion-capable apparatuses to execute the conversion processing, via the corresponding CEC line, and also instructs the other apparatuses to prohibit the conversion processing, via the corresponding CEC line.

Meanwhile, if the AV amplifier 22 and the TV 23 each of which is the controlled conversion-capable apparatus provide the DVD player 21 which is the HDMI® source with their equipment information containing at least capable/incapable information representing whether the apparatuses are capable of performing conversion processing, and if capable of performing conversion processing, each apparatus controls the execution of the conversion processing in accordance with an instruction from the DVD player received via the CEC line.

Accordingly, a single apparatus among the DVD player 21, the AV amplifier 22, and the TV 23 is selected as the executing apparatus, and the conversion processing is performed by only the executing apparatus, thereby performing proper conversion processing.

Namely, it is prevented that conversion processing is performed in plural ones of the DVD player 21, the AV amplifier 22, and the TV 23, and that conversion processing performed by one of the apparatus affects conversion processing performed by the other(s) to degrade eventually the quality of an image displayed on the TV 23.

Furthermore, in the manual mode, the user needs to perform an operation of setting the format for an image signal converted by the converting processing by operating each of the DVD player 21, the AV amplifier 22, and the TV 23, whereas in the select mode, selection of the executing apparatus from the conversion-capable apparatus is performed in response to a user operation on the resolution setting menu (FIG. 8), and then an image corresponding to an image signal resulting from the conversion processing executed by the executing apparatus selected in response to the user operation is displayed on the TV 23.

Accordingly, the user can easily select a conversion-capable apparatus which executes conversion into an image signal having a user's favorite image quality, while viewing the image displayed on the TV 23.

Furthermore, when the autoselect mode is selected, selection of the executing apparatus from the conversion-capable apparatus is performed on the basis of the level information, and thus image signal formats can be converted through the most superior conversion processing.

In the foregoing, embodiments in which the present invention is applied to conversion processing for converting image signal formats has been described. The present invention may also include other embodiments in which, e.g., audio signal formats (e.g., a sampling rate and the like) are to be converted.

It is noted that in the present embodiment, both the AV amplifier 22 and the TV 23 connected to the DVD player 21 are supposed to be conversion-capable apparatus. However, if either the AV amplifier 22 or the TV 23 is not a conversion-capable apparatus, neither a prohibition signal nor an execution signal is transmitted to the HDMI® apparatus which is not a conversion-capable apparatus from the DVD player 21. Furthermore, in the HDMI® apparatus which is not a conversion-capable apparatus, the processing according to the flowcharts shown above in FIGS. 11 and 12 is not performed. Furthermore, no display regarding the HDMI® apparatus which is not a conversion-capable apparatus is made on the resolution setting menu (FIG. 8).

Furthermore, in the present embodiment, the HDMI® has been employed as an interface. The present invention may be applicable to other interfaces having at least a signal channel unidirectionally transmitting a baseband signal and a bidirectional control channel used for control.

Here, in the present specification, the processing steps describing a program for causing a computer (the CPU 101 (FIG. 3), the CPU 201 (FIG. 4), the CPU 301 (FIG. 5)) to perform various processing are not necessarily performed time-sequentially in order of the steps described in the flowcharts, but may include processing (e.g., parallel processing or object-oriented processing) executed parallelly or individually.

Furthermore, the program may be executed by a single computer, or executed by a plurality of computers in a distributed manner.

It is noted that embodiments of the present invention are not limited to the embodiments described above, but may be modified in various ways without departure from the scope and spirit of the present invention.

For example, in the present embodiment, the DVD player 21 which is the HDMI® source is designated as a so-called master for transmitting an execution signal or a prohibition signal, and the AV amplifier 22 which is the HDMI® repeater and the TV 23 which is the HDMI® sink are designated as slaves for performing the processing in accordance with the execution signal or the prohibition signal from the master. However, alternatively, by designating the TV 23 which is the HDMI® sink as a master and by designating the DVD player 21 which is the HDMI® source and the AV amplifier 22 which is the HDMI® repeater as salves, it may be configured such that the TV 23 as the master transmits an execution signal or a prohibition signal to the slaves and the DVD player 21 and the AV amplifier 22 which are the salves perform the processing in accordance with the execution signal or the prohibition signal from the master. Namely, if the DVD player 21 is the master, the DVD player 21 includes the format button for switching the processing-mode transition shown in FIG. 7 and the resolution setting menu corresponding to FIG. 8, whereas if the TV 23 is the master, the TV 23 includes a format button for switching the processing-mode transition equivalent to FIG. 7 and a resolution setting menu (resolution setting menu for TV) equivalent to FIG. 8. A processing-mode transition diagram and the resolution setting menu for TV are not shown because they are substantially the same as FIGS. 7 and 8.

Furthermore, if the TV 23 is the master, the TV 23 performs processing equivalent to FIGS. 9 and 10. Therefore, since a processing flow is almost the same when the roles are switched between the DVD player 21 and the TV 23 in FIGS. 9 and 10, a detailed description thereof is omitted. In such case, the DVD player 21 performs processing equivalent to FIG. 12. Therefore, since the role in FIG. 12 is switched from the DVD player 21 to the TV 23, a processing flow thereof is almost the same, a detailed description thereof is omitted.

Furthermore, according to Appendix A Repeater (Page 134) of the HDMI® Specification (Non-Patent Document 1), the HDMI® repeater has the following modes. In one of the modes, the HDMI® repeater behaves as a mirror of the HDMI® sink by copying EDID about the HDMI® sink and storing the copied EDID as EDID about the HDMI® repeater. In the other mode, the HDMI® repeater does not have an EDIDROM, but forwards the EDID about the HDMI® sink upon request from the HDMI® source. The present invention is applicable to both modes.

Furthermore, in the present embodiment, equipment information in EDID stored in the EDIDROM 413 (FIG. 6) contains capable/incapable information. Alternatively, it may be possible to store the capable/incapable information in a storage different from the EDIDROM 413, such as, e.g., the ROM 103 (or ROM 203 or 303), and cause an HDMI® apparatus which is a slave to provide the capable/incapable information stored in the different storage in response to a request from an HDMI® apparatus which is a master. The HDMI® apparatus as the salve may provide the information, e.g., via the CEC line of the HDMI®.

Namely, e.g., the HDMI® repeater may sometimes have no EDIDROM, as described above. Thus, for an HDMI® apparatus having no EDIDROM, it may be possible to store the capable/incapable information in a different storage as described above, and provide the information by request from a master.

What is claimed is:

1. A communication apparatus connected to one or more apparatuses via an interface having at least a signal channel unidirectionally transmitting a baseband signal and a bidirectional control channel used for control, the communication apparatus comprising:
means for obtaining equipment information about each of the one or more apparatuses connected via the interface, containing at least capable/incapable information representing whether the apparatus is capable of performing conversion processing for converting a format of the signal;
selection means for selecting a single apparatus from the communication apparatus and the one or more apparatuses capable of performing the conversion processing, as an executing apparatus in which the conversion processing should be executed; and
instruction means for instructing, when the executing apparatus is the communication apparatus, all of the one or more apparatuses capable of performing the conversion processing to prohibit the conversion processing, via the control channel, and
instructing, when the executing apparatus is one of the one or more apparatuses capable of performing the conversion processing, the executing apparatus of the one or more apparatuses capable of performing the conversion processing to execute the conversion processing, via the control channel, and also instructing the communication apparatus to prohibit the conversion processing and other apparatus to prohibit the conversion processing, via the control channel.

2. The communication apparatus according to claim 1, further comprising means for obtaining level information on superiority or inferiority of the conversion processing performed by each of the communication apparatus and the one or more apparatuses capable of performing the conversion processing,
wherein the selection means selects the executing apparatus on the basis of the level information.

3. The communication apparatus according to claim 1, wherein the selection means selects the executing apparatus in response to a user operation.

4. The communication apparatus according to claim 1, wherein:
the interface is an HDMI®, and
the communication apparatus is an HDMI® source, an HDMI® sink, or an HDMI® repeater.

5. An information processing method for a communication apparatus connected to one or more apparatuses via an interface having at least a signal channel unidirectionally transmitting a baseband signal and a bidirectional control channel used for control, the communication apparatus comprising the steps of:
obtaining, by the communication apparatus, information about each of the one or more apparatuses connected via the interface, containing at least capable/incapable information representing whether the apparatus is capable of performing conversion processing for converting a format of the signal;
selecting a single apparatus from the communication apparatus and the one or more apparatuses capable of performing conversion processing, as an executing apparatus in which the conversion processing should be executed; and
instructing, when the executing apparatus is the communication apparatus, all of the one or more apparatuses capable of performing the conversion processing to prohibit the conversion processing, via the control channel, and
instructing, when the executing apparatus is one of the one or more apparatuses capable of performing the conversion processing, the executing apparatus of the one or more apparatuses capable of performing the conversion processing to execute the conversion processing, via the control channel, and also instructing the communication apparatus to prohibit the conversion processing and other apparatus to prohibit the conversion processing, via the control channel.

6. A computer readable medium including a program for causing a computer to function as a communication apparatus connected to one or more apparatuses via an interface having at least a signal channel unidirectionally transmitting a baseband signal and a bidirectional control channel used for control, the program comprising:
means for obtaining equipment information about each of the one or more apparatuses connected via the interface, containing at least capable/incapable information representing whether the apparatus is capable of performing conversion processing for converting a format of the signal;
means for selecting a single apparatus from the communication apparatus and the one or more apparatuses capable of performing the conversion processing, as an executing apparatus in which the conversion processing should be executed; and
means for instructing, when the executing apparatus is the communication apparatus, all of the one or more apparatuses capable of performing the conversion processing to prohibit the conversion processing, via the control channel, and
instructing, when the executing apparatus is one of the one or more apparatuses capable of performing the conversion processing, the executing apparatus of the one or more apparatuses capable of performing the conversion processing to execute the conversion processing, via the control channel, and also instructing the communication apparatus to prohibit the conversion processing and other apparatus to prohibit the conversion processing, via the control channel.

7. A communication apparatus connected to another apparatus via an interface having at least a signal channel unidirectionally transmitting a baseband signal and a bidirectional control channel used for control, the communication apparatus comprising:
means for providing equipment information about the communication apparatus containing at least capable/incapable information representing whether the apparatus is capable of performing conversion processing for converting a format of the signal, to the another apparatus; and
control means for controlling execution of the conversion processing in accordance with an instruction from the another apparatus received via the control channel when the apparatus is capable of performing the conversion processing.

8. The communication apparatus according to claim 7, wherein:
the interface is an HDMI®, and
the communication apparatus is an HDMI® source, an HDMI® sink, or an HDMI® repeater.

9. An information processing method for a communication apparatus connected to another apparatus via an interface having at least a signal channel unidirectionally transmitting a baseband signal and a bidirectional control channel used for control, the information processing method comprising the steps of:
providing, by the communication apparatus, equipment information about the communication apparatus containing at least capable/incapable information representing whether the apparatus is capable of performing conversion processing for converting a format of the signal, to the another apparatus; and
controlling execution of the conversion processing in accordance with an instruction from the another apparatus received via the control channel when the apparatus is capable of performing the conversion processing.

10. A computer readable medium including a program for causing a computer to function as a communication apparatus connected to another apparatus via an interface having at least a signal channel unidirectionally transmitting a baseband signal and a bidirectional control channel used for control, the program comprising:
means for providing equipment information about the communication apparatus containing at least capable/incapable information representing whether the apparatus is capable of performing conversion processing for converting a format of the signal, to the another apparatus; and
means for controlling execution of the conversion processing in accordance with an instruction from the another apparatus received via the control channel when the apparatus is capable of performing the conversion processing.

11. A communication apparatus connected to one or more apparatuses via an interface having at least a signal channel unidirectionally transmitting a baseband signal and a bidirectional control channel used for control, the communication apparatus comprising:
an equipment information obtaining unit configured to obtain equipment information about each of the one or more apparatuses connected via the interface, containing at least capable/incapable information representing whether the apparatus is capable of performing conversion processing for converting a format of the signal;
a selection unit configured to select a single apparatus from the communication apparatus and the one or more apparatuses capable of performing the conversion processing, as an executing apparatus in which the conversion processing should be executed; and
an instruction unit configured to instruct, when the executing apparatus is the communication apparatus, all of the one or more apparatuses capable of performing the conversion processing to prohibit the conversion processing, via the control channel, and
instruct, when the executing apparatus is one of the one or more apparatuses capable of performing the conversion processing, the executing apparatus of the one or more apparatuses capable of performing the conversion processing to execute the conversion processing, via the control channel, and also instructing the communication apparatus to prohibit the conversion processing and other apparatus to prohibit the conversion processing, via the control channel.

12. A communication apparatus connected to another apparatus via an interface having at least a signal channel unidirectionally transmitting a baseband signal and a bidirectional control channel used for control, the communication apparatus comprising:
a providing unit configured to provide equipment information about the communication apparatus containing at least capable/incapable information representing whether the apparatus is capable of performing conversion processing for converting a format of the signal, to the another apparatus; and
an execution control unit configured to control execution of the conversion processing in accordance with an instruction from the another apparatus received via the control channel when the apparatus is capable of performing the conversion processing.
